(19) United States
(12) Patent Application Publication
(10) Pub. No.: US 2007/0043852 A1
(43) Pub. Date: Feb. 22, 2007

(54) System and method of HTML transaction logging in a web based (HTTP) customer contact center

(75) Inventors: Edwin Robbins JR., Sandown, NH (US); W. James Gillis JR., Andover, MA (US); Aaron Bentley Flett, Merrimack, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: CIM Ltd., San Francisco, CA (US)

(21) Appl. No.: 11/204,618

(22) Filed: Aug. 16, 2005

(51) Int. Cl. G06F 15/173

(52) U.S. Cl. 709/224

(57) ABSTRACT

The present invention includes a system and method of HTML transaction logging in a Web based HTTP protocol contact center. The system includes a central processing unit operatively connected to a server having a filter portion and a servlet container. A storage facility is operatively connected to the filter portion of the server. The filter portion has a plurality of filters operatively connected in series or chainable, wherein the filters are configured such that each filter is processed in the order of the configuration. The agent, via the central processing unit, requests logging of a particular HTML transaction. The server receives the request and communicates it to the servlet container. The servlet container creates a response to the request, unique logging tokens and objects and associates them with the request and the response. The plurality of filters parse the request and the response for the unique logging tokens and objects to determine if the HTML transaction is to be logged. If so, the plurality of filters sends the HTML transaction to the storage facility where it is logged. Thereafter, a supervisor or qualified agent can access the HTML transaction and satisfy the customers requirements.

### TECHNICAL FIELD OF THE INVENTION

The present invention relates to a contact center system and more particularly, relates to a system and method of HTML transaction logging in a Web based HTTP protocol customer contact center.

### DESCRIPTION OF THE RELATED ART

Many businesses and customer service organizations utilize contact centers to communicate with customers or potential customers (hereinafter collectively “customers”) . For example, telemarketers may utilize contact centers to perform telemarketing campaigns. However, in contact centers today, agents use various methods of communication. For example, agents may use text-based messaging, such as e-mails, Web chat, Instant Messenger, Chat rooms, etc., to communicate with customers.

During communication by telephone, agents may desire or be required to record or log a call. For example, a customer may request information or a service that the agent cannot satisfy. In that case, the agent records the communication so that a qualified agent or supervisor can follow-up and satisfy the requirements of the customer. Unfortunately, the recording or logging is strictly limited to the actual voice conversation between the agent and customer.

However, with the advent of newer technologies (e.g., e-mails, Web chat, Instant Messenger, Chat rooms, etc.) and specifically the use of the HTTP protocol within a contact center, the need for greater flexibility in logging is required.

Based on the foregoing, it is apparent that there is a need for a system and method for identifying, tagging, logging, and recalling an HTML transaction in a Web based HTTP protocol customer contact center.

### SUMMARY OF THE INVENTION

The present invention includes a system and method for tagging, logging, and recalling an HTML transaction in a Web based protocol customer contact center. An agent may log an ongoing HTML transaction because the agent is not able to satisfy the requirements of the customer or because the content of the contact requires logging, such as for security purposes.

Specifically, an agent initiates a request for logging an HTML transaction by sending the request to a server. The server communicates the request to a servlet container, and the servlet container creates a response to the request, unique logging tokens, and request and response objects for both the request and the response. The unique logging tokens and objects indicate that the HTML transaction is to be logged. A filter portion parses the request and the response to determine if the HTML transaction is to be logged. If the HTML transaction is to be logged, the filter portion sends the HTML transaction to a storage facility for logging.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawing wherein:

FIG. 1 is a block diagram of a system of HTML transaction logging in a Web based HTTP protocol customer contact center according to the present invention.

### DETAILED DESCRIPTION OF THE PREFERRED EMBODIMENTS

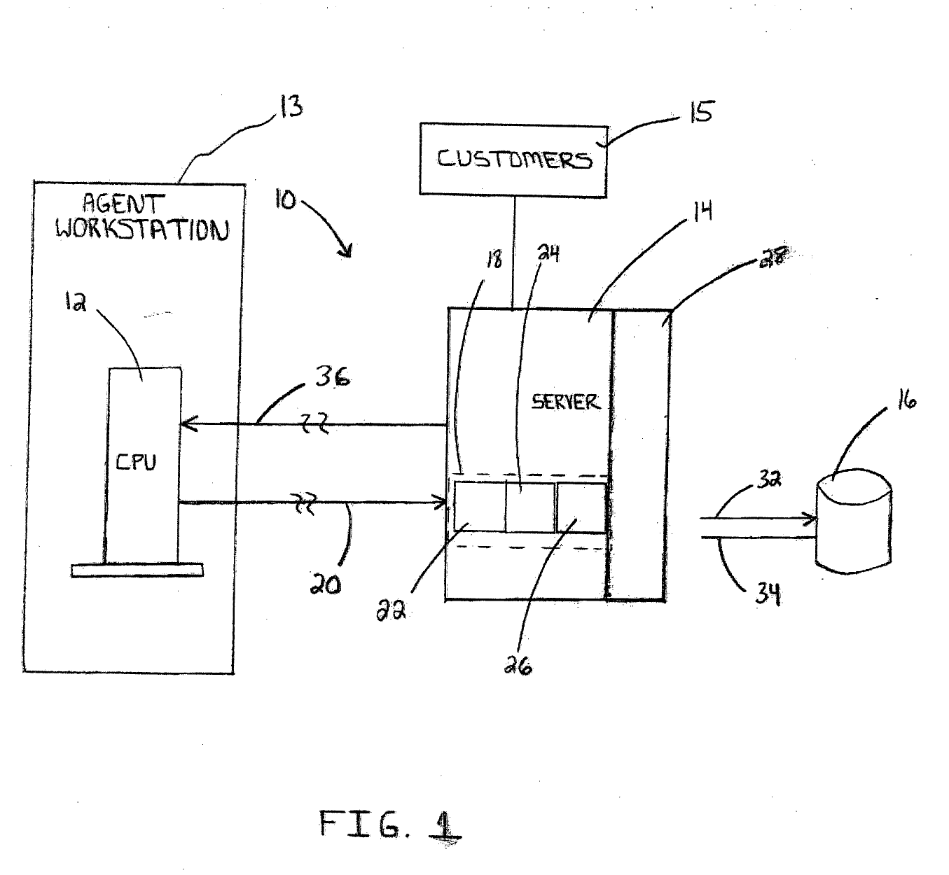

The present invention includes a system 10, FIG. 1, and method of tagging, logging, and recalling HTML transactions in a Web based protocol contact center. The Web based protocol may be a HyperText Transfer Protocol (HTTP), HyperText Transfer Protocol over Secure socket layer (HTTPS), or other file transfer protocol. An agent is an individual working at an agent workstation 13 within the contact center environment that interfaces with customers represented generally as 15 through a server 14. The agent workstation typically has a central processing unit (hereinafter “CPU”) 12, typically a personal computer, for utilizing a Web browser to interface with customers 15, which in turn connects to a server 14 in the contact center. The interface is not limited to a Web browser; other HTTP or HTTPS file viewing and sharing application may be used. The agent workstation 13 may also include a telephone set (not show).

While working on a contact within the contact center environment, the agent may at any time originate a request 20, through the CPU 12 to the server 14, to save or log an HTML transaction. For example, the agent may originate or initiate the request 20 to save or log an ongoing HTML transaction because the agent is not able or doesn't have the skills necessary to satisfy the requirements of the customer, or is required by law or the employer to log the HTML transaction. If the agent is not qualified to handle the specific HTML transaction and an agent having the required skills is not available, the agent may initiate the request 20 to log the HTML transaction so that at some time in the future, an agent having the required skills may access the logged HTML transaction, review what has previously transpired, and make a follow-up contact. In another instance, the agent may be required to save or log the HTML transaction because of the content of the contact. For example, certain states require that when a customer requests a change from one long distance carrier to another, the communication must be saved or logged. In another instance, the employer of the agent may require the agent to save or log certain contacts. For example, an agent may be instructed to save or log communications with certain businesses or individuals or concerning certain types of transactions such as the sale of stocks or bonds.

The system 10 for tagging, logging, and recalling an HTML transaction in a Web based HTTP protocol contact center in accordance with the present invention includes a server 14 having a servlet container 28. The servlet container 28 must have a minimum specification of JSR-000053 Java Servlet 2.3 Servlet Specification. The Tomcat 4.x server is an example of a server 14 having an acceptable minimum specification servlet container 28 and is available through Apache Software Foundation. The servlet container 28 provides a runtime environment in which Web applications run, as well as the tools necessary to deploy Web applications.

The server 14 also has a filter interface or portion 18. The filter portion 18 may be a set of code that executes and process the data. The filter portion 18 may be java class software, which processes the request 20 or response 36. The filter portion 18 may occur either pre or post processing by the server processor. For example, the filter portion 18 may determine that either the request 20 or the response 36 for logging has been initiated and communicate that the HTML transaction should be logged with a storage facility 16. The filter portion 18 may be a single filter or multiple filter working in conjunction in a modular fashion.

The storage facility 16 is operatively connected to the filter portion 18 of the server 14 and is used to store or log the HTML transaction between the agent and the customer. There are various devices that can be used as the storage facility 16 for storing or logging HTML transactions and for later retrieval and analysis. For example, Relational Databases, XML databases, Lightweight Directory Access Protocol (LDAP) directory, directory, flat file systems, such as a hard drive, and other file systems may be used as the storage facility 16.

In use, the agent makes the request 20 for logging to the server 14 via the CPU 12. The server 14 communicates the request 20 to the servlet container 28. In tandem with receiving the request 20, the servlet container 28 of the server 14 will create request and response objects and a response 36. The request and response objects represent the HTML transaction between the customer and the agent. The request object contains all pertinent information about the request 20 and the response object is based on the response 36. For example, but not limit to, the request and response objects may include the IP address, Destination address, request path, request context, etc. of the customer. The servlet container 28 passes the response object to the filter portion 18 and then back to the agent's CPU 12 as part of the response 36. It is important to note that neither the request nor response objects are sent to the customer. Below is table of an example request and response for a potential catalog customer.

| | |
|---|---|
| Request | Response |

| | | | |
|---|---|---|---|
| Name | Aaron Buyer | Name | Aaron Buyer |
| Inquiry | Product | Inquiry | Product |
| | availability | | availability |
| Reference ID | 1051005 | Reference ID | 1051005 |
| Agent | Undefined | Agent | Joe Frontline |
| Initiated | customer | Initiated | agent |
| Session ID | 1000201 | Session ID | 1000201 |

The request objects associated with the above request include “Aaron Buyer”, “Product availability”, “105100”, “Undefined” and “customer”. The request objects are the values that are added to the HTTP request. Similarly, the response objects associated with above response include “Aaron Buyer”, “Product availability”, “105100”, “Joe Frontline” and “agent”. The response objects are the values that are added to the HTTP response. The request objects and response objects are not limited to the above example. The request objects and response objects may be a variety of values and to the above-defined fields.

In addition, the servlet container 28 creates unique logging tokens for both the request 20 and the response 36. The unique logging token is a string identifier that is used to keep HTML transactions separate from each other. The unique logging token may also be the presence of a string. In the above example request 20 and response 36, the logging token may be any of the request objects or response objects. For example, if transactions with customers are intended to be logged, the logging token may be the presence of a customer name string. The presence of the string “Aaron Buyer” or any string in under the customer name triggers the logging of the request or response. In another example the logging token may be a specific string. For example, “Joe Frontline” in the agent string would provide tracking of transaction for only agent, “Joe Frontline”. The logging token may be selected based on the desired application or logging protocol.

The transactions come in from the customer via a client application, for example, a web browser that is communicating using the HTTP protocol. The request 20 is placed into the server 14 or servlet container 28, which in turn has a filter portion 18 set up to preprocess the request 20. The filter portion 18 is set to identify the logging tokens desired for the record. The filter portion 18 examines the request 20 to determine if unique logging tokens have been associated with a designated request 20 for logging. If unique logging tokens have been associated with a designated request 20, the filter portion 18 communicates with the storage facility 16 to log the HTML transaction. The storage facility 16 then stores the HTML transaction. The request 20 is routed to an agent who is accepting requests via a servlet running in the servlet container 28. The servlet can deliver and distribute the request 20 in variety of manners. For example, the agents may poll the servlet. In another example the servlet may place the request 20 in a queue, which is than interrogated by an application of the agent.

The agent response 36 may go through the web server 14 or servlet container 28 in the reverse fashion back to the customer allowing for filtering to take place on the response 36. The response 36 is placed into the server 14 or servlet container 28, which in turn has a filter portion 18 set up to preprocess the response 36. The filter portion 18 is set to identify the logging tokens desired for the record, as previous discussed with regard to requests. If the response is associated with a designated logging token, the storage facility 16 then stores the HTML transaction. The response 36 is routed to the customer via a servlet running in the servlet container 28. The servlet can deliver and distribute the response 36 to the customer, as previous discussed with regard to delivery of requests 20 to agents.

The communication between the storage facility 16 and the filter portion 18 includes a storage request 32 and a return reply 34. Specifically, the filter portion 18 may include a plurality of filters 22, 24, 26 that are operatively connected in series or in a chain. In FIG. 1, three filters 22, 24, 26 are shown; however, the number of filters will depend upon the desired function as explained below.

In the preferred embodiment, the system 10 has a first filter 22, a second filter 24, and a third filter 26. It is important to note that each filter performs a different function. In alternative embodiments, additional filters are added to perform additional functions. An additional filter may be incorporated into the system 10 to send reminders to the agent responsible for the follow-up, or the supervisor responsible for assigning the HTML transaction to a qualified agent.

In the preferred embodiment, after the agent has made the request 20 for logging, the first filter 22 builds the logging session request by initiating the storage request 32 with the storage facility 16. After the first filter 22 has initiated the storage request 32, the request 20 is passed to the second filter 24 in the chain. The second filter 24 examines the request 20 to determine if logging has been requested, and if so, the second filter 24 sends the HTML transaction to the storage device 16 for logging. The third filter 26 is used to detect when a HTML transaction has been logged by the storage facility 16, and if so, the third filter 26 sends notification to a qualified agent to handle the HTML transaction or to a supervisor for assignment to a qualified agent. Again, additional filters may be incorporate into the system 10 to send reminders to the agent receiving the notification to handle the HTML transaction, or the supervisor responsible for assigning the HTML transaction to a qualified agent. The filters may perform a variety of agent tasks that may be preprogrammed in the filter and reducing the required interaction by agents.

In summary, the agent initiates the request 20 for logging the HTML transaction by sending the request 20 to the server 14. The server 14 communicates the request 20 to the servlet container 28, and the servlet container 28 creates request and response objects and unique logging tokens for both the request 20 and the response 36. The filter portion 18 interprets the request 20 and the response 36 to determine if the HTML transaction is to be logged. If so, the HTML transaction is logged into the storage facility 16.

To terminate the logging session, the agent requests termination of the logging process, and the first filter 22 described above will reverse the process. Specifically, the first filter 22 builds the termination session request with the storage facility 16. Specifically, the first filter 24 notifies the storage facility 16 of a pending termination, and the servlet container 28 will remove the unique token from the HTML transaction. The second filter 24 examines the request 20 to determine if termination has been requested, and if so, the second filter 24 terminates the HTML transaction. HTML transaction logging will also automatically terminate with the conclusion of the particular session.

After an HTML transaction has been logged, a qualified agent or supervisor may access the logged HTML transaction by a gateway and complete the required action. For example, the agent with the required skill may access the HTML transaction and respond to the customer. The access may be limited to a select group of agents or supervisors. The access may be provided in a variety of manners to allow an agent or supervisor to efficiently access the logged HTML transaction. The manner of access may also provide the agent or supervisor with an interface to facilitate a review or a required action of the logged HTML transactions.

Accordingly, the present invention provides a system 10 and method for tagging, logging or saving, and recalling an HTML transaction between the agent and the customer in a Web based HTTP protocol customer contact center.

It is important to note that the present invention is not intended to be limited to a device or method which must satisfy one or more of any stated or implied objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the following claims.

What is claimed is:

1. A system for logging an HTML transaction in a Web based contact center, the system comprising:
at least one central processing unit for initiating a request to log the HTML transaction;
a server, responsive to said at least one central processing unit, and having a servlet container and filter portion, for receiving the request to log the HTML transaction, and for automatically generating a response to the request;
wherein the servlet container creates unique logging tokens, and request and response objects when the request from the central processing unit is received, and for associating the unique logging tokens and objects with the request and the response;
wherein the filter portion parses the request and the response for the unique logging tokens and the objects to determine if the HTML transaction is to be logged; and
a storage facility, for receiving the HTML transaction from the filter portion if the HTML transaction is to be logged and for storing.

2. The system for logging HTML transactions in a Web based contact center according to claim 1, wherein the unique logging token is a unique string identifier.

3. The system for logging HTML transactions in a Web based contact center according to claim 1, wherein the storage facility is a Relational Database.

4. The system for logging HTML transactions in a Web based contact center according to claim 1, wherein the storage facility is an XML database.

5. The system for logging HTML transactions in a Web based contact center according to claim 1, wherein the storage facility is a Lightweight Directory Access Protocol directory.

6. The system for logging HTML transactions in a Web based contact center according to claim 1, wherein the storage facility is a flat file system.

7. The system for logging HTML transactions in a Web based contact center according to claim 6, wherein the flat file system is a hard drive.

8. The system for logging HTML transactions in a Web based contact center according to claim 1, wherein the filter portion includes a plurality of filters.

9. The system for logging HTML transactions in a Web based contact center according to claim 8, wherein the plurality of filters include a first filter, for initiating a storage request to the storage facility.

10. The system for logging HTML transactions in a Web based contact center according to claim 9, wherein the plurality of filters include a second filter, for sending the HTML transaction to the storage facility for logging.

11. The system for logging HTML transactions in a Web based contact center according to claim 10, wherein the plurality of filters include a third filter, for notifying a supervisor that the HTML transaction has been logged in the storage facility.

12. The system for logging HTML transactions in a Web based contact center according to claim 9, wherein the plurality of filters include a third filter, for notifying a qualified agent that the HTML transaction has been logged in the storage facility.

13. The system for logging HTML transactions in a Web based contact center according to claim 11, further including a gateway for retrieving the logged HTML transaction.

14. The system for logging HTML transactions in a Web based contact center according to claim 12, further including a gateway for retrieving the logged HTML transaction.

15. A system for HTML transaction logging in a Web based contact center, the system comprising:
a computer for initiating a request for a logging session;
a server, for receiving the request, and a servlet container of the server, for generating a response, unique logging tokens and objects indicative that the HTML transaction is to be logged, and for adding said unique logging tokens and objects to the request and the response;
a first filter, for initiating a storage request to a storage facility if the request contains the unique logging tokens and the objects;
a second filter, for sending the HTML transaction to the storage facility for logging if the first filter detects the unique logging tokens and the objects; and
wherein the storage facility receives and logs the HTML transaction from the second filter.

16. The system for HTML transaction logging in a Web based contact center according to claim 15, wherein the first filter initiates a termination of the logging session when a termination command is received from the computer.

17. The system for HTML transaction logging in a Web based contact center according to claim 16, wherein the first filter notifies the storage facility of the termination command.

18. A method of HTML transaction logging in a Web based contact center, the method comprising the acts of:
initiating a request for logging the HTML transaction from a central processing unit;
communicating the request from the central processing unit to a server;
responsive to said communicating act, automatically generating a response to the request by the server to the central processing unit;
responsive to said initiating and generating acts, automatically creating unique identifier tokens, and request and response objects with a servlet container of the server, and associating the unique tokens and objects with the response and the request;
responsive to said generating act, automatically parsing the request and the response for unique logging tokens and objects to determine if the HTML transaction is to be logged by a filter portion; and
responsive to said parsing act, automatically logging the HTML transaction in a storage facility if the HTML transaction is to be logged.

19. The method of HTML transaction logging in a Web based contact center according to claim 18, the method further comprising the act of terminating the logging session.

20. The method of HTML transaction logging in a Web based contact center according to claim 19, wherein the terminating act further comprises the act of notifying the storage facility of the pending termination.

21. The method of HTML transaction logging in a Web based contact center according to claim 20, and responsive to said notifying act, and further comprising the act of removing the unique logging tokens.
